(19) United States
(12) Patent Application Publication
(10) Pub. No.: US 2009/0277311 A1
(43) Pub. Date: Nov. 12, 2009

(54) Adjustable plier device

(75) Inventor: Larry Alford, Perth (AU)

Correspondence Address: CHARLES E. BAXLEY, ESQUIRE, 90 JOHN STREET, SUITE 309, NEW YORK, NY, 10038, US

(73) Assignee: Hand Tools International Taiwan Corp.

(21) Appl. No.: 12/152,061

(22) Filed: May 12, 2008

(51) Int. Cl. B25B 7/12; B25B 7/02; B25B 7/04

(52) U.S. Cl. 81/355; 81/418; 81/407

(57) ABSTRACT

An adjustable plier device includes a handle having a stationary jaw member and a number of teeth extended into a groove of the handle, a movable jaw member slidably attached to the handle and having a curved recess for pivotally engaging with a follower which includes a toothed pawl for engaging with the teeth of the handle and having a curved depression for pivotally engaging with one end of a lever, and an actuating member pivotally coupled to the handle and the lever for actuating the lever to quickly force the movable jaw member to grasp the work piece, and to force the toothed pawl to engage with the teeth of the handle and to retain the work piece between the jaw members.

### BACKGROUND OF THE INVENTION

1. Field of the Invention

The present invention relates to an adjustable plier device, and more particularly to an adjustable plier device including an improved structure for allowing the plier device to be easily and quickly operated by the user and to be quickly engaged with the fastener or the work piece.

2. Description of the Prior Art

Typical adjustable pliers or plier devices comprise a stationary plier member, a slidable member slidably attached to the stationary plier member, and an actuating handle pivotally attached to the stationary plier member and coupled to the slidable member for moving the slidable member relative to the stationary plier member and for adjustably clamping the fasteners or the work pieces of different diameters between the stationary plier member and the slidable member.

For example, U.S. Pat. No. 5,050,465 to Haugs discloses one of the typical pliers device also comprising an actuating handle pivotally attached to a stationary plier member and coupled to the slidable member with a toothed wheel for actuating the slidable member to move relative to the stationary plier member and to grasp or clamp or grip the fasteners or the work pieces of different diameters between the stationary plier member and the slidable member.

However, it is required to apply a great torque to the actuating handle in order to actuate the slidable member to move relative to the stationary plier member such that the typical pliers device may not be easily operated by the users with a decreased working force or torque.

U.S. Pat. No. 5,134,908 to Fisher discloses another typical pliers device comprising a pivot pin attached to one handle member and slidably engaged in a rectangular slot of the other handle member for actuating the handle members to grasp or clamp or grip the fasteners or the work pieces of different diameters.

However, similarly, it is required to apply a great torque to the handle members in order to actuate the handle members to grasp or clamp or grip the fasteners or the work pieces such that the typical pliers device also may not be easily operated by the users with a decreased working force or torque.

U.S. Pat. No. 5,568,752 to Alford discloses a further typical pliers device comprising a handle including a stationary jaw member, a slidable jaw member slidably attached to the handle and slidable along the handle, and a level pivotally coupled to the slidable jaw member for grasping or clamping or gripping the fasteners or the work pieces of different diameters between the jaw members.

However, similarly, it is required to apply a great torque to the handle and the level in order to actuate the jaw members to grasp or clamp or grip the fasteners or the work pieces such that the typical pliers device also may not be easily operated by the users with a decreased working force or torque.

U.S. Pat. No. 5,685,205 to Suksi discloses a still further typical pliers device comprising a slide member slidably attached to an elongated handle and slidable along the handle, and another actuating handle pivotally attached to the slide member for grasping or clamping or gripping the fasteners or the work pieces of different diameters between the elongated handle and the actuating handle and/or the slide member.

However, similarly, it is required to apply a great torque to the handles in order to actuate the handles to grasp or clamp or grip the fasteners or the work pieces such that the typical pliers device also may not be easily operated by the users with a decreased working force or torque.

U.S. Pat. No. 6,014,917 to Bally et al. discloses a still further typical pliers device comprising a pivot pin attached to one handle member and slidably engaged in a curved positioning slot of the other handle member for actuating the handle members to grasp or clamp or grip the fasteners or the work pieces of different diameters.

However, similarly, it is required to apply a great torque to the handle members in order to actuate the jaw members to grasp or clamp or grip the fasteners or the work pieces such that the typical pliers device also may not be easily operated by the users with a decreased working force or torque.

The present invention has arisen to mitigate and/or obviate the afore-described disadvantages of the conventional adjustable plier devices.

### SUMMARY OF THE INVENTION

The primary objective of the present invention is to provide an adjustable plier device including an improved structure for allowing the plier device to be easily and quickly operated by the user and to be quickly engaged with the fastener or the work piece.

In accordance with one aspect of the invention, there is provided an adjustable plier device comprising an elongated handle including a middle portion, a first end portion having a stationary jaw member provided thereon, and a second end portion having a hand grip provided thereon, and including a groove formed in the first end portion of the handle, and a number of teeth extended into the groove of the handle, a movable jaw member slidably attached to the first end portion of the handle and movable toward and away from the stationary jaw member and for adjustably grasping a work piece between the stationary jaw member and the movable jaw member, the movable jaw member including a curved recess formed therein, a follower including a curved surface formed thereon for pivotally engaging with the curved recess of the movable jaw member and for pivotally attaching the follower to the movable jaw member and for allowing the follower to be pivoted relative to the movable jaw member, the follower including a toothed pawl slidably engaged in the groove of the handle for selectively engaging with the teeth of the handle, and including a curved depression formed therein, a lever including a curved first end portion pivotally engaged with the curved depression of the follower for allowing the follower and the lever to be pivotally coupled together, and including a middle portion for being forced to selectively engage with the peg of the handle, and including a second end portion, a spring member coupled between the follower and the lever for biasing the toothed pawl of the follower away from the teeth of the handle, and an actuating member including a middle portion pivotally coupled to the handle with a pivot pin, and including an end portion pivotally coupled to the second end portion of the lever with a pivot pole for actuating the lever to pivot around the peg, and to selectively force the follower and the movable jaw member to move toward the stationary jaw member and to grasp the work piece between the stationary jaw member and the movable jaw member, and to selectively force the toothed pawl of the follower to engage with the teeth of the handle in order to retain the work piece between the stationary jaw member and the movable jaw member when the actuating member is further pulled and forced toward the handle, and for allowing the plier device to be easily and quickly operated by the user and to be quickly engaged with the fastener or the work piece.

The movable jaw member includes a projection extended into the curved recess of the movable jaw member for forming a compartment in the movable jaw member which is communicating with the curved recess of the movable jaw member for receiving the toothed pawl of the follower.

The follower includes a shaft extended therefrom and slidably engaged in the groove of the handle for guiding the follower and the movable jaw member to slide toward and away from the stationary jaw member.

The follower includes two studs for forming the curved depression of the follower between the studs. The spring member is coupled between one of the studs of the follower and the middle portion of the lever.

The lever includes a curved notch formed in the middle portion of the lever for pivotally engaging with the peg. The actuating member includes an extension extended from the middle portion of the actuating member for pivotally coupling to the handle with the pivot pin.

The handle includes two handle members secured together with fasteners, and the handle members each include a channel formed therein, and the movable jaw member includes two ribs extended therefrom and slidably engaged with the channels of the handle members for slidably coupling the movable jaw member to the handle.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of an adjustable plier device in accordance with the present invention;

FIG. 2 is a perspective view of the adjustable plier device;

FIG. 3 is a perspective view illustrating a follower for the adjustable plier device;

FIG. 4 is a partial perspective view of the adjustable plier device in which a portion of the adjustable plier device has been removed for showing the inner structure of the adjustable plier device; and

FIG. 5 is a partial perspective view similar to FIG. 4, illustrating the operation of the adjustable plier device.

### DETAILED DESCRIPTION OF THE PREFERRED EMBODIMENT

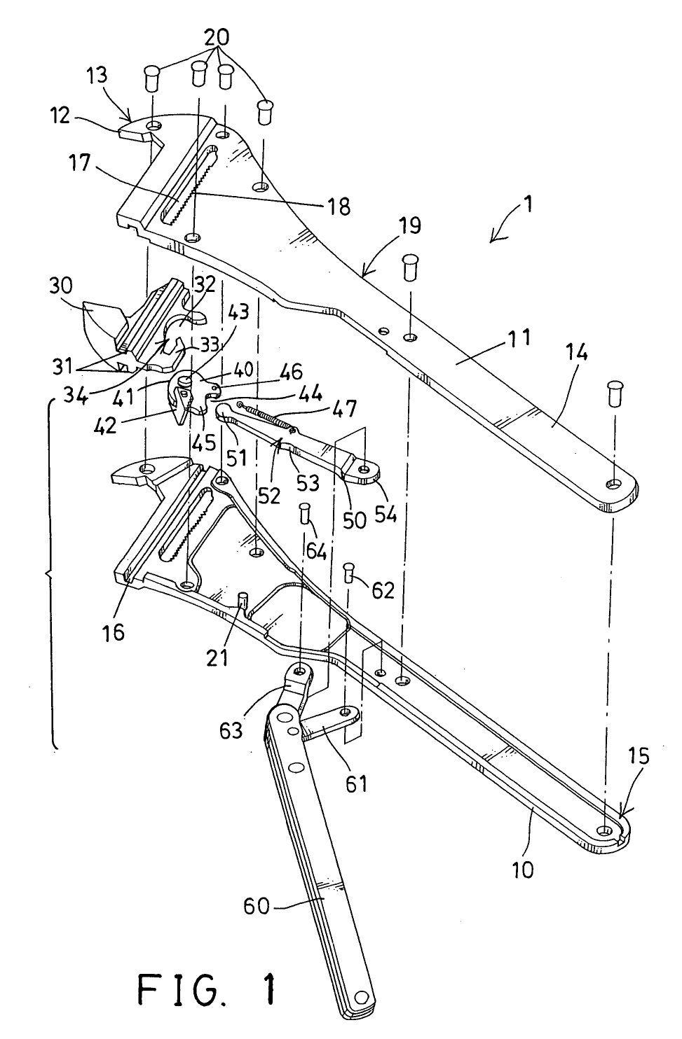

Referring to the drawings, and initially to FIGS. 1, 2 and 4, an adjustable plier device in accordance with the present invention comprises an elongated handle 1 including two handle members 10, 11 secured together with such as rivets or fasteners 20, and including a fixed or stationary jaw member 12 formed or provided on one end portion 13 of the handle members 10, 11 or of the handle 1, and including a hand grip 14 formed or provided on one end portion 15 of the handle members 10, 11 or of the handle 1 for being gripped or grasped or held by the user, and including a channel 16 laterally formed in the one end portion 13 of each of the handle members 10, 11 or of the handle 1 for slidably attaching a movable jaw member 30.

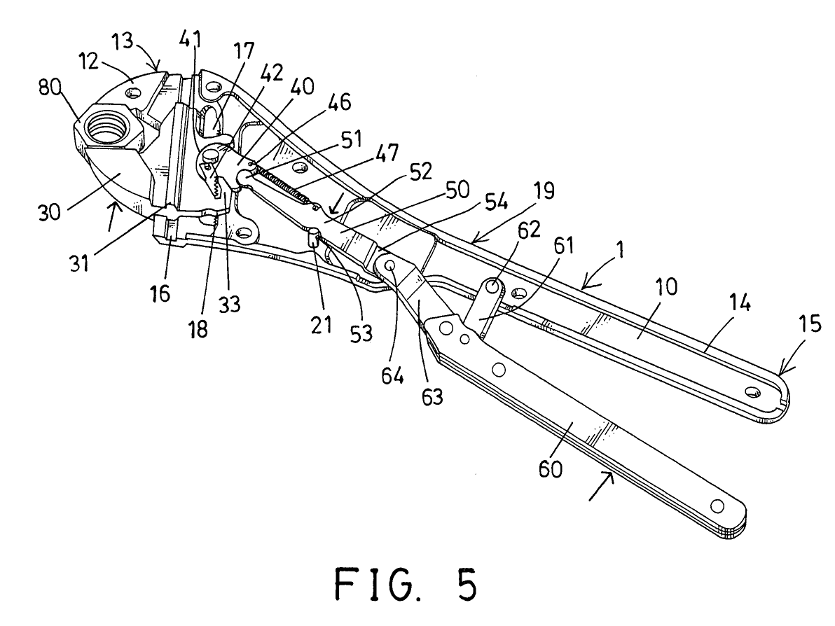

For example, the movable jaw member 30 includes one or more (such as two) ribs 31 laterally extended outwardly therefrom for slidably engaging with the channels 16 of the handle members 10, 11 or of the handle 1 and for allowing the movable jaw member 30 to slide toward or away from or relative to the stationary jaw member 12 and for adjustably grasping or clamping the fasteners or the work pieces 80 of different diameters between the stationary jaw member 12 and the movable jaw member 30 (FIG. 5). The handle 1 further includes a groove 17 also laterally formed in the one end portion 13 of each of the handle members 10, 11 or of the handle 1, and preferably parallel to the channels 16 of the handle members 10, 11, and a rack or a number of teeth 18 formed or extended into the groove 17 of each of the handle members 10, 11 or of the handle 1. The above-described structure is typical and will not be described in further details.

The movable jaw member 30 includes a curved recess 32 formed therein for pivotally attaching or receiving a follower 40, and includes a projection 33 extended toward or into the curved recess 32 of the movable jaw member 30 for forming or defining a compartment 34 in the movable jaw member 30 which is communicating with the curved recess 32 of the movable jaw member 30. The follower 40 includes a curved surface 41 formed in one end portion thereof for pivotally engaging with the curved recess 32 of the movable jaw member 30 and for pivotally attaching or securing the follower 40 to the movable jaw member 30 and for allowing the follower 40 to be pivoted or rotated relative to the movable jaw member 30.

The follower 40 further includes a toothed pawl 42 extended outwardly therefrom or attached thereto and slidably engaged in the grooves 17 of the handle members 10, 11 or of the handle 1 for selectively engaging with the teeth 18 of the handle members 10, 11 or of the handle 1 when the follower 40 is pivoted or rotated relative to the movable jaw member 30. It is preferable that the follower 40 further includes a shaft 43 laterally extended therefrom and slidably engaged in the grooves 17 of the handle members 10, 11 or of the handle 1 for guiding the follower 40 and the movable jaw member 30 to slide toward or away from or relative to the stationary jaw member 12 and for preventing the follower 40 and the movable jaw member 30 from being disengaged from the handle members 10, 11 or the handle 1.

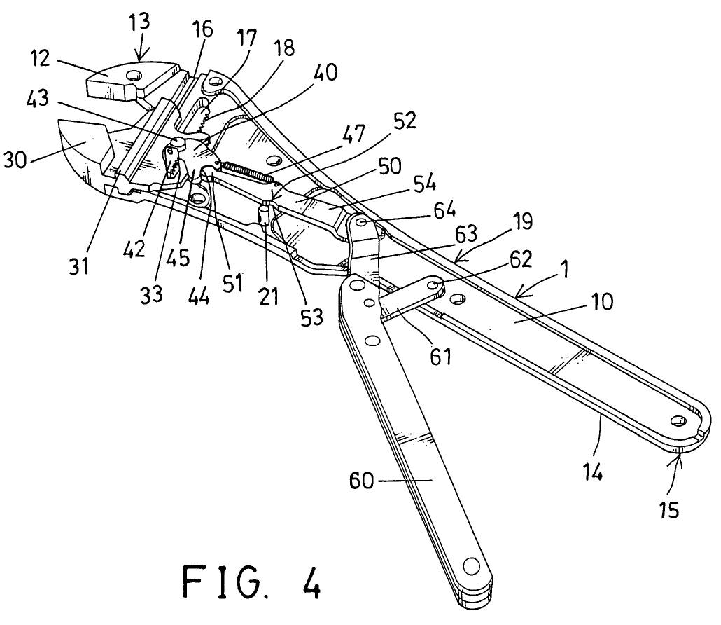

The follower 40 further includes a curved depression 44 formed therein (FIGS. 1, 3) and formed or defined between two studs 45, 46 for pivotally attaching or receiving or coupling a lever 50, in which one of the studs 46 is coupled to a spring biasing means or member 47 for applying a spring biasing force to the follower 40 and for biasing or forcing the toothed pawl 42 of the follower 40 away from the teeth 18 of the handle members 10, 11 or of the handle 1 (FIG. 4), and also for biasing or forcing the follower 40 and the lever 50 toward each other. For example, the lever 50 includes a curved end portion 51 for rotatably or pivotally attaching or coupling to the curved depression 44 of the follower 40 for allowing the follower 40 and the lever 50 to be pivotally coupled together.

The lever 50 is slidably attached or engaged between the handle members 10, 11 of the handle 1, and includes a middle portion 52 coupled to the spring member 47 for allowing the spring member 47 to pivotally couple the follower 40 and the lever 50 together, and includes a curved notch 53 formed in the middle portion 52 thereof for pivotally engaging with a stop or peg 21 which is extended or secured between the handle members 10, 11 of the handle 1, and preferably located at the middle portion 19 of the handle 1, and includes another end portion 54 located opposite to or distal to the follower 40 and the movable jaw member 30, and/or arranged for allowing the peg 21 to be disposed or located between the end portions 51, 54 of the lever 50 and for allowing the lever 50 to be rotated or pivoted around the peg 21 (FIG. 5).

An actuating arm or hand grip or member 60 includes an extension or middle portion 61 pivotally coupled to the middle portion 19 of the handle 1 with a pivot pin 62 for allowing the actuating member 60 to be forced or moved toward or away from the end portion 15 of the handle members 10, 11 or of the handle 1 (FIGS. 4, 5), and includes another extension or one end portion 63 pivotally coupled to the other end portion 54 of the lever 50 with a pivot pole 64 for actuating the lever 50 to move or to rotate or to pivot around the peg 21. The extensions or the middle portion and the one end portion 61, 63 of the actuating member 60 may be formed integral with the actuating member 60, or may be formed as a one-integral portion of the actuating member 60.

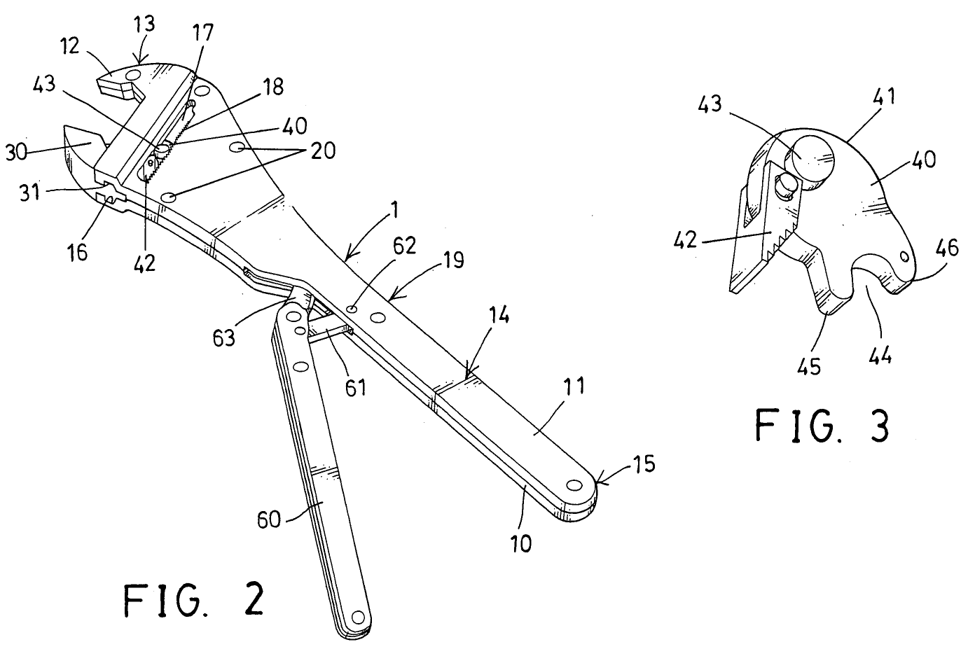

In operation, as shown in FIGS. 2 and 4, when the actuating member 60 is not pulled or moved toward the end portion 15 of the handle members 10, 11 or of the handle 1 by the user, the middle portion 52 of the lever 50 may be moved away from the peg 21, and the follower 40 may be moved or forced to pivot or to rotate relative to the movable jaw member 30 by the spring member 47 in order to bias or to force the toothed pawl 42 of the follower 40 away from the teeth 18 of the handle members 10, 11 or of the handle 1. At this moment, the movable jaw member 30 may be easily and quickly moved toward or away from the work pieces 80 of different diameters.

As shown in FIG. 5, when the actuating member 60 is pulled or moved or forced toward the end portion 15 of the handle members 10, 11 or of the handle 1 by the user, the middle portion 52 of the lever 50 may be moved or forced toward the peg 21, and the lever 50 may then be forced to rotate or to pivot around the peg 21. At this moment, the other end portion 54 of the lever 50 will be forced to move out of the handle 1, and the curved end portion 51 of the lever 50 will force or move the follower 40 and the movable jaw member 30 toward the work piece 80 and to solidly engage with the work piece 80. When the actuating member 60 is further pulled or moved or forced toward the end portion 15 of the handle members 10, 11 or of the handle 1, the follower 40 may further be forced to rotate relative to the movable jaw member 30, and the toothed pawl 42 of the follower 40 may then be forced to engage with the teeth 18 of the handle members 10, 11 or of the handle 1, in order to solidly retain the work piece 80 between the stationary jaw member 12 and the movable jaw member 30.

Accordingly, the adjustable plier device in accordance with the present invention includes an improved structure for allowing the plier device to be easily and quickly operated by the user and to be quickly engaged with the fastener or the work piece.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An adjustable plier device comprising:
an elongated handle including a middle portion, a first end portion having a stationary jaw member provided thereon, and a second end portion having a hand grip provided thereon, and including a groove formed in said first end portion of said handle, and a plurality of teeth extended into said groove of said handle,
a movable jaw member slidably attached to said first end portion of said handle and movable toward and away from said stationary jaw member and for adjustably grasping a work piece between said stationary jaw member and said movable jaw member, said movable jaw member including a curved recess formed therein,
a follower including a curved surface formed thereon for pivotally engaging with said curved recess of said movable jaw member and for pivotally attaching said follower to said movable jaw member and for allowing said follower to be pivoted relative to said movable jaw member, said follower including a toothed pawl slidably engaged in said groove of said handle for selectively engaging with said teeth of said handle, and including a curved depression formed therein,
a lever including a curved first end portion pivotally engaged with said curved depression of said follower for allowing said follower and said lever to be pivotally coupled together, and including a middle portion for being forced to selectively engage with said peg of said handle, and including a second end portion,
a spring member coupled between said follower and said lever for biasing said toothed pawl of said follower away from said teeth of said handle, and
an actuating member including a middle portion pivotally coupled to said handle with a pivot pin, and including an end portion pivotally coupled to said second end portion of said lever with a pivot pole for actuating said lever to pivot around said peg, and to selectively force said follower and said movable jaw member to move toward said stationary jaw member and to grasp the work piece between said stationary jaw member and said movable jaw member, and to selectively force said toothed pawl of said follower to engage with said teeth of said handle in order to retain the work piece between said stationary jaw member and said movable jaw member when said actuating member is further pulled and forced toward said handle.

2. The adjustable plier device as claimed in claim 1, wherein said movable jaw member includes a projection extended into said curved recess of said movable jaw member for forming a compartment in said movable jaw member which is communicating with said curved recess of said movable jaw member for receiving said toothed pawl of said follower.

3. The adjustable plier device as claimed in claim 1, wherein said follower includes a shaft extended therefrom and slidably engaged in said groove of said handle for guiding said follower and said movable jaw member to slide toward and away from said stationary jaw member.

4. The adjustable plier device as claimed in claim 1, wherein said follower includes two studs for forming said curved depression of said follower between said studs.

5. The adjustable plier device as claimed in claim 4, wherein said spring member is coupled between one of said studs of said follower and said middle portion of said lever.

6. The adjustable plier device as claimed in claim 1, wherein said lever includes a curved notch formed in said middle portion of said lever for pivotally engaging with said peg.

7. The adjustable plier device as claimed in claim 1, wherein said actuating member includes an extension extended from said middle portion of said actuating member for pivotally coupling to said handle with said pivot pin.

8. The adjustable plier device as claimed in claim 1, wherein said handle includes two handle members secured together, and said handle members each include a channel formed therein, and said movable jaw member includes two ribs extended therefrom and slidably engaged with said channels of said handle members for slidably coupling said movable jaw member to said handle.
